(19) United States
(12) Patent Application Publication
(10) Pub. No.: US 2023/0278934 A1
(43) Pub. Date: Sep. 7, 2023

(54) METHODS OF CARBONATING CEMENT POWDER

(71) Applicant: Magnum Cementing Services Operations Ltd., Strathmore (CA)

(72) Inventor: Shaun T. Mesher, Calgary (CA)

(21) Appl. No.: 18/102,682

(22) Filed: Jan. 27, 2023

Related U.S. Application Data
(60) Provisional application No. 63/303,965, filed on Jan. 27, 2022.

(51) Int. Cl. C04B 40/02; C04B 7/52; C04B 7/51; C04B 7/44; C04B 7/47; C04B 7/42; C04B 22/06; C04B 22/12; C04B 28/02; C09K 8/46

(52) U.S. Cl. CPC C04B 40/0231; C04B 40/0281; C04B 7/52; C04B 7/51; C04B 7/44; C04B 7/47; C04B 7/427; C04B 22/064; C04B 22/12; C04B 28/02; C09K 8/46; C04B 2111/74

(57) ABSTRACT

A method of carbonating cement powder and use thereof. An amount of water is supplied to an initial cementitious powder to create a moistened cementitious powder. Carbon dioxide is supplied to the moistened cementitious powder, while mechanically stirring the moistened cementitious powder, to cause a reaction of the carbon dioxide with the moistened cementitious powder to produce a carbonated cementitious material. The carbonated cementitious material is dried and ground to produce a carbonated cementitious powder. The carbonated cementitious powder may be combined with ordinary cement and various ingredients or additives, such as retarders, accelerators and extenders for use in well cementing applications. Methods for cementing casing, liners and remedial operations such as plugging back, and squeeze cementing are also provided. Methods for producing a low alkaline cement suitable for high CO₂ gas wells are also provided. Methods to achieve a stable retarded cement used in higher temperatures are provided.

### PRIORITY CLAIM

This application claims the benefit of priority from U.S. provisional application No. 63/303,965, filed Jan. 27, 2022, the contents of which are incorporated herein by reference.

### FIELD OF THE INVENTION

This relates to methods of carbonating cement powder and uses thereof.

### BACKGROUND OF THE INVENTION

Cement is typically an alkaline particle reacted with water to form a solid rock. To make that rock, a number of chemicals are heated up to 1600° C. and drive off a lot of carbon dioxide (CO₂). In conventional cement projects, one ton of CO₂ is estimated to be emitted per ton of cement made. Conventional methods of cement production emit significant amounts of CO₂. According to some estimates, cement is the source of about 8% of the world's CO₂ emissions. There have been attempts to sequester carbon in cement, but some of these attempts result in degradation of cement quality.

Portland cement manufacturing generates various by-products, including CO₂ created during calcination and burning of raw materials, heat energy provided by firing hydrocarbon fuels is a large contributor of CO₂ emissions. Portland cement manufacturers increasingly seek technology and processes that reduce the potential environmental impact during manufacturing.

### SUMMARY OF THE INVENTION

In one embodiment there is disclosed a method of carbonating cement powder. An initial cementitious powder is provided. An amount of water is supplied to the initial cementitious powder to create a moistened cementitious powder. Carbon dioxide is supplied to the moistened cementitious powder, while mechanically stirring the moistened cementitious powder, to cause a reaction of the carbon dioxide with the moistened cementitious powder to produce a fully or partially carbonated cementitious material. The fully or partially carbonated cementitious material is dried and ground to produce a fully or partially carbonated cementitious powder.

In various embodiments, there may be included any one or more of the following features: the amount of water added to the initial cementitious powder is less than 5% by weight of the initial cementitious powder; controlling the reaction of the carbon dioxide with the moistened cementitious powder, the fully or partially carbonated cementitious material being a partially carbonated cementitious material and the fully or partially carbonated cementitious powder being a partially carbonated cementitious powder; the control of the reaction of the carbon dioxide with the moistened cementitious powder comprises controlling the amount of water; the control of the reaction of the carbon dioxide with the moistened cementitious powder comprises monitoring a pH of the moistened cementitious powder and controlling the reaction according to the monitored PH; the amount of water is supplied to the initial cementitious powder as a mist; the amount of water is supplied to the initial cementitious powder as a stream; the amount of water is supplied to the initial cementitious powder as a vapor; the carbon dioxide is supplied to the moistened cementitious powder substantially at atmospheric pressure; cooling the moistened cementitious powder during the reaction of the carbon dioxide with the moistened cementitious powder; the initial cementitious powder is provided by providing a mixture of ground calcareous materials and ground argillaceous materials, heating the mixture to a temperature sufficient to calcine and fuse the ground materials to form a cement clinker, cooling the cement clinker, and grinding the cement clinker to produce the initial cementitious powder; the carbon dioxide supplied to the initial cement powder is obtained from an exhaust gas of an industrial process; the step of heating the mixture to a temperature sufficient to calcine and fuse the ground materials produces an exhaust gas containing carbon dioxide, and the carbon dioxide supplied to the moistened cementitious powder is obtained from the exhaust gas; the carbon dioxide is separated from the exhaust gas before it is supplied to the moistened cementitious powder; the carbon dioxide is supplied to the moistened cementitious powder by supplying the exhaust gas to the moistened cementitious powder without separating the carbon dioxide; adding a binder to the fully or partially carbonated cementitious material or to the fully or partially carbonated cementitious powder; the binder is added to the fully or partially carbonated cementitious powder; the binder is added in a mixing step in which water is also added; the binder is added to the fully or partially carbonated cementitious powder before adding water; the fully or partially carbonated cementitious material or the fully or partially carbonated cementitious powder is substantially fully carbonated cementitious material or substantially fully carbonated cementitious powder; the binder comprises an oxide; the oxide is magnesium oxide; the binder comprises a hydroxide; the hydroxide is sodium hydroxide; the binder comprises ferric chloride (FeCl₃); including the fully or partially carbonated cementitious powder in a concrete for civil use; including the fully or partially carbonated cementitious powder in a concrete for marine use; including the fully or partially carbonated cementitious powder as the whole or part of a cementitious component of a concrete for use in a wellbore; the wellbore is the bore of an oil or gas well; the oil or gas well is an acid gas well; the wellbore is the bore of a water well; the wellbore is the bore of a geothermal well; the wellbore is the bore of a carbon dioxide injection well; the cementitious component of the concrete includes a mixture comprising the fully or partially carbonated cementitious powder and ordinary Portland cement; the cementitious component includes a hydraulic cement; a retarder is included in the concrete for use in the wellbore; the retarder is included in a quantity of about 0.05%-0.45% of the weight of the cementitious component of the concrete; the concrete includes an accelerator for use in the wellbore; the concrete includes a dispersant for use in the wellbore; the concrete includes an extender for use in the wellbore; the concrete includes one or more of hydrated lime, alkali ions, calcium sulfate, calcium chlorides or an organic component; the wellbore is a high CO₂ gas wellbore; the wellbore is a high temperature wellbore; the concrete is used in completion of the wellbore; the concrete is placed outside of a casing of the wellbore; the concrete is placed between a liner and a casing of the wellbore; the concrete is used in a remedial wellbore operation; the remedial operation is a squeeze cementing operation; the concrete is used in a plugging back operation; the plugging back operation is an abandonment operation.

The foregoing summary is not intended to summarize each potential embodiment or every aspect of the subject matter of the present disclosure.

### BRIEF DESCRIPTION OF THE DRAWINGS

Preferred and alternative examples of the present invention are described in detail below with reference to the following drawings. Furthermore, embodiments will now be described with reference to the FIGURES, in which like reference characters denote like elements, by way of example, and in which:

FIG. 1 is a chart showing the atmospheric CO₂ carbonation of cement clinker versus time, which shows the formation of different products with different PHs at different times.

FIG. 2 is a chart showing the compressive strength of various mixes of cements after the cement solidified over a number of days at 20 deg. C.

FIG. 3 is a chart showing the compressive strength of various mixes of cements after the cement solidified over a number of days at 50 deg. C.

FIG. 4 is a chart showing the compressive strength of various mixes of cements at 80 deg. C.

FIG. 5 is an image showing different colors of various cement mixes after solidification. The colors of the samples are white with light grey inclusions on the left, white on the second from the left, brown in the center, dark brownish-black on the second from the right, and nearly black on the right.

FIG. 6 is an image showing different colors of various cement mixes including iron chloride after solidification. The colors are dark yellow on the left sample and light brownish yellow with white throughout on the right sample.

FIG. 7 is an image showing different colors of various cement mixes including magnesium oxide after solidification. The colors of the samples are various shades of brown with white throughout.

FIG. 8 is a graph showing amounts of mass loss of cement samples on heating.

FIG. 9 is a graph showing the compressive strengths of cement blends and additives.

FIG. 10 shows a method of carbonating a cementitious powder.

FIG. 11 shows a method of producing an initial cementitious powder.

FIG. 12 shows a method of adding a binder and water to a carbonated cementitious powder.

### DETAILED DESCRIPTION OF THE PREFERRED EMBODIMENT

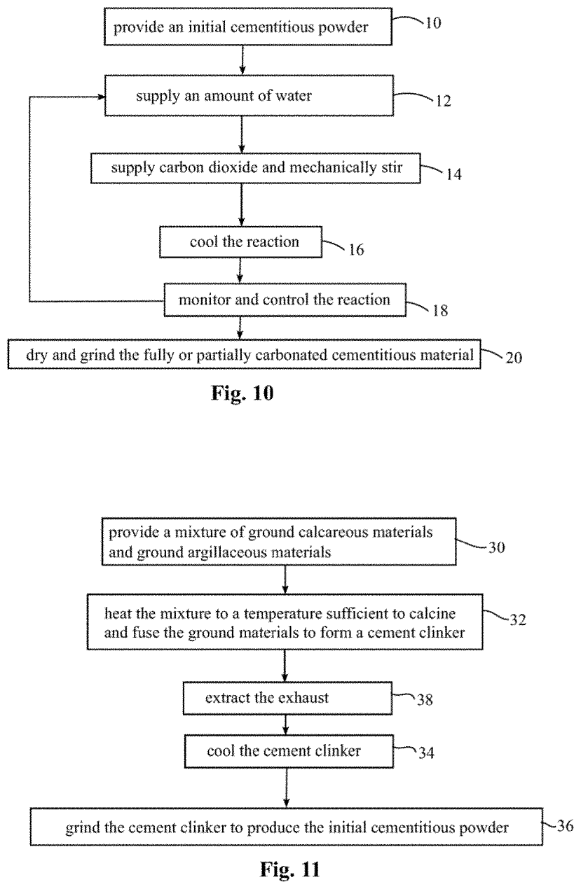

In an embodiment, as shown in FIG. 10, there is disclosed a method of carbonating cement powder. An initial cementitious powder is provided 10. Any cementitious powder may be used as the initial cementitious powder, including ordinary Portland cement (OPC). Any class of OPC known in industry may be used, including classes A-H per API Spec 10A; types I to V per ASTM 150; CEM I to V per EN 197 Norm; GU, GUL, MS, MH, MHL, HE, HEL, LH, LHL, or HS per CSA A3000/A3001; or GU, HE, MS, HS, MH, LH per ASTM C1157. An amount of water is supplied to the initial cementitious powder to create a moistened cementitious powder 12. Carbon dioxide is supplied to the moistened cementitious powder, while mechanically stirring the moistened cementitious powder 14, to cause a reaction of the carbon dioxide with the moistened cementitious powder to produce a fully or partially carbonated cementitious material. The fully or partially carbonated cementitious material is dried and ground to produce a fully or partially carbonated cementitious powder 20. Because the reaction of CO₂ with the cement is exothermic, the heat will assist with evaporating water out of the cement. Stirring/grinding may help to dry the cement off more efficiently. A dry product is useful for storage. Stirring while drying will help get rid of the water and dry the product faster.

The amount of water added to the initial cementitious powder may be less than 5% by weight of the initial cementitious powder. The amount of water may be supplied to the initial cementitious powder as a mist, a stream or a vapor. The reaction of the carbon dioxide with the moistened cementitious powder may be controlled and the fully or partially carbonated cementitious material may be a partially carbonated cementitious material and the fully or partially carbonated cementitious powder may be a partially carbonated cementitious powder. The control of the reaction of the carbon dioxide with the moistened cementitious powder may include monitoring aspects of the reaction in step 18. Depending on the monitoring, steps 12-18 may be repeated with parameters controlled according to the results of the monitoring. These parameters may include, for example, the amount of water 12 added or the amount of carbon dioxide supplied in step 14. The monitoring may comprise for example monitoring a pH of the moistened cementitious powder. The carbon dioxide may be supplied to the moistened cementitious powder substantially at atmospheric pressure. The carbon dioxide may be supplied to the initial cement powder after being obtained from an exhaust gas of an industrial process. The moistened cementitious powder may be cooled during the reaction of the carbon dioxide with the moistened cementitious powder 16.

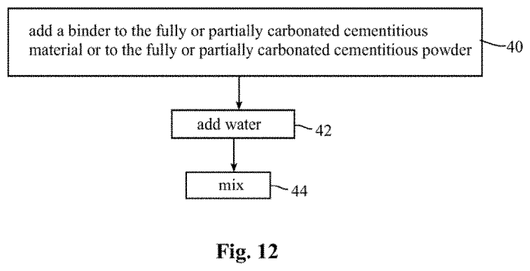

A method of obtaining the initial cementitious powder is shown in FIG. 11. An initial cementitious powder may be provided by the steps of: providing a mixture of ground calcareous materials and ground argillaceous materials 30, heating the mixture to a temperature sufficient to calcine and fuse the ground materials to form a cement clinker 32, optionally extracting the exhaust gas produced by the heating 38, cooling the cement clinker 34, and grinding the cement clinker to produce the initial cementitious powder 36. The step of heating the mixture to a temperature sufficient to calcine and fuse the ground materials 32 produces an exhaust gas 38 containing carbon dioxide and the carbon dioxide supplied to the moistened cementitious powder 14 may optionally be obtained from the exhaust gas 38. The carbon dioxide may be separated from the exhaust gas before it is supplied to the moistened cementitious powder. The carbon dioxide may be supplied to the moistened cementitious powder by supplying the exhaust gas to the moistened cementitious powder without separating the carbon dioxide. A binder may be added to the fully or partially carbonated cementitious material or to the fully or partially carbonated cementitious powder 40 (as shown in FIG. 12). The fully or partially carbonated cementitious material or the fully or partially carbonated cementitious powder may be substantially fully carbonated cementitious material or substantially fully carbonated cementitious powder. The binder may be added to the fully or partially carbonated cementitious powder in a mixing step in which water is also added 42, 44 (as shown in FIG. 12). The binder may be added to the fully or partially carbonated cementitious powder before adding water. The binder may include an oxide, such as magnesium oxide or OPC. The binder may include a hydroxide such as sodium hydroxide. The binder may be ferric chloride (FeCl₃). The fully or partially carbonated cementitious powder may be included in a concrete for civil or marine use or in a concrete for use in a wellbore, the wellbore may be for example an oil or gas well.

The oil or gas well may be an acid gas well. The well bore may be the bore of a water well. The well bore may be the bore of a geothermal well. The wellbore may be the bore of a carbon dioxide injection well. The wellbore may be a high CO₂ gas wellbore or a high temperature wellbore. The concrete may be used in a completion of a wellbore. The concrete may be placed outside of a casing of the wellbore. The concrete may be placed between a liner and a casing of a wellbore. The concrete may be used in a remedial wellbore operation, for example the remedial operation may be a squeeze cementing operation. The concrete may be used in a plugging back operation, wherein for example the plugging back operation is an abandonment operation.

The fully or partially carbonated cementitious powder may be the whole or part of a cementitious component of a concrete for use in a wellbore. The cementitious component of the concrete may include a mixture of the fully or partially carbonated cementitious powder and ordinary Portland cement. Further, the cementitious component may include a hydraulic cement.

The concrete for use in a wellbore may include a retarder, for example in quantities of 0.05%-0.45% of the weight of the cementitious component of the concrete. The concrete may further include any one or more of an accelerator, a dispersant, an extender, hydrated lime, alkali ions, calcium sulfate, calcium chlorides, or an organic component.

In embodiments of the methods of carbonating cement powder, the process may start with dry ordinary Portland cement (OPC). In previous attempts to carbonate cement, carbonation of cement and concrete typically takes place after the cement has set or while it is a liquid paste. In standard cement applications where carbonation is added to the cement, the amount of cement added may be limited because excess CO₂ may destroy the cement. Aged cement may crumble with exposure to environmental CO₂.

The embodiment disclosed herein may not require using aged recycled concrete pieces, aged in CO₂ rich systems or adding non-calcium rich minerals to lower the pH for environmental protection and corrosion issues.

Wet CO₂ corrosion in well bore cement is an issue that causes cement to crack and leak, this leads to failure of the well bore and expensive repairs. Wellbore cement may have a pH above 12 because of the excess calcium hydroxide binder. CO₂ corrosion may occur as the mobile carbonic acid water phase seeps into the immobile alkaline phase of the cement and causes the excess calcium hydroxide to react to form calcium carbonates. These carbonates may expand in the cement structure of the well bore and cause cracking and channeling to occur. The embodiment provided may use a fully or partially carbonated cement powder, which assists to achieve a sufficiently low pH cement to make a CO₂ resistant well bore cement system.

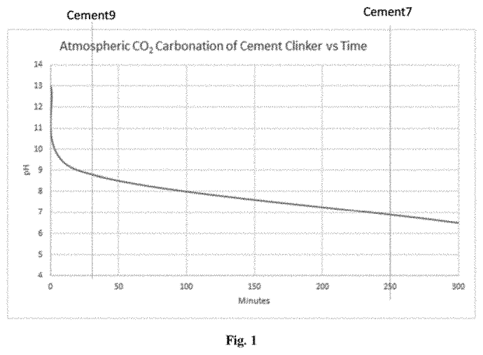

An embodiment provides carbonated cement or concrete by the reaction of dry hydraulic cement powder with various elements including CO₂ and water in an amount which may be less than 5% H2O. The process may comprise: (i) wetting the cement powder with a small amount of water 12; and (ii) carbonating the cement powder with carbon dioxide 14. Cooling may be used to minimize the water loss during the exothermic reaction 16. The cement powder may then be dried 20. The CO₂ used may be pure or in the form of industrial emissions. The amount of CO₂ added to the powder may be controlled and monitored 18 yielding a fully carbonated cement powder pH=7 or a 75% carbonated cement powder pH=9 or other PH values with other carbonated cement amounts. Because of the way the cement powder reacts with CO₂, different types of carbonated cement may be created by varying the amount of CO₂ added and time needed to react to the initial cement (OPC). For example, exposure to CO₂ may be stopped after 30 minutes resulting in a pH of 9 or after 3 hours resulting in a pH of 7. These are called cement 9 (C9) and cement 7 (C7), the 9 stands for pH=9 and the 7 stands for pH=7, as shown in FIG. 1. The carbonated powder may then be used to make hydraulic cement and concrete blends containing various amounts of trapped CO₂ or for other forms and purposes for cement.

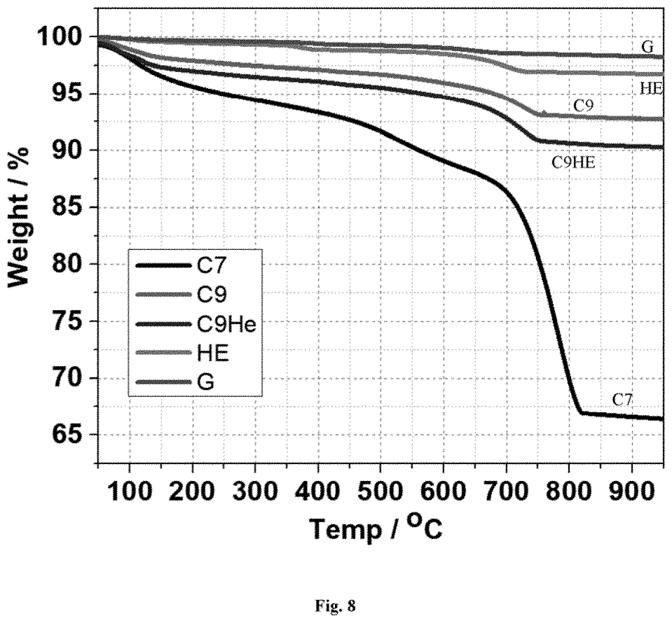

FIG. 8 shows mass loss on heating for samples of different types of cement heated to 1000 deg. C on a mass balance. As the sample gets hotter, CO₂ is removed from the solid and the mass of the sample gets lighter. Cement G is oil well cement (OWG which is OPC class G per API spec 10A). HE is high early strength cement (OPC-HE which is specified as OPC class C per API spec 10A). Also shown are two varieties of cement9, one version (C9) made with OWG as the initial cementitious powder, and another version (C9HE) made with HE as the initial cementitious powder. The version of cement? shown (C7) was made with OWG as the initial cementitious powder.

Neat cement sample OWG (also defined as Neat G) and HE loss on heating is 1.7673% and 3.27402% respectively. C9HE and C9 loss on heating is 6.44551% and 5.50319% respectively. C7 loss on heating is 31.85201%.

The neat cements (OWG and HE) and the carbonated ones (C9, C9HE, and C7) are heated in a similar manner. While it is possible that some of the mass loss is due to removal of water, it is expected that the large majority of the mass loss is due to CO₂. Cement 7 has thus likely absorbed close to 31.85% of its weight in CO₂ and Cement 9 (2 samples) has absorbed close to 6.5% and 5.5% respectively. What this shows is that the maximum amount of CO₂ absorbed into the cement via this method is high, at likely close to 31.85% and the amount can be varied simply by extending the amount of time the cement particle is in contact with the CO₂ gas.

Hydraulic cement typically uses calcium hydroxide to act as the binder between the cement particles and the aggregate. The amount of calcium hydroxide present in Portland cement is typically present in greater amounts than is necessary to create a solid form, hence the elevated pH levels in many commercial grades of finished cement and concrete. Carbonation of the cement powder, pre-hydration, converts the hydroxides into carbonates, eliminating most of the hydroxides present in the Portland cement. Lime or another binder may be reintroduced in a controlled manner to achieve the desired physical properties while minimizing the pH levels in the final solid cement form.

Various binders may be used as described below. The binders may be added to a fully or partially carbonated cementitious material, or to a fully or partially carbonated cementitious powder produced by grinding fully or partially carbonated cementitious material once it is fully dry. Some of the binders could react with the water during the drying phase so would be better to add the binder after the drying phase. For example, MgO and NaOH could react with the water during the drying phase.

The binder could also be added by the user at the use site.

Some binders may alternatively in some cases be added before drying. However, some oil field cement jobs are programmed at the time of pumping based on variables of the actual wellbore, so adding a binder before may not be helpful if you need to use a different binder. Because there are numerous binders, we would want to add a binder based on the job being programmed. For example, MgO swells a cement, so it would be used in applications to fill gaps in the surrounding wellbore.

The embodiments disclosed may remove all the PH with CO₂ and then add lime or other compounds back in to get back to the properties the user requires.

In an embodiment, the cement is made, all the emissions may be trapped and then put back into the cement. The lime or other compound may be added, and a specific type of quick setting cement may be created.

Embodiments of the methods disclosed may allow for control of the final product and may be manipulated with addition of binder, lime or other binders, being added back in to achieve the final result. A disclosed embodiment may be readily scaled up and allow for capturing CO₂ emissions and trapping the CO₂ permanently in the ground or other purposes.

In one embodiment, the partial (75%) carbonation product may be made easily because the Portland cement may react quickly (30 minutes) and then to get to the remaining 100% may take 2.5 hours more—less time is also possible however.

Cement is typically an alkaline particle reacted with water to form a solid rock. Typically, the rock with a number of chemicals may be heated to 1600° C. and drive off a lot of CO₂. Typically, one ton of CO₂ is made per ton of cement made. Previous attempts of cement carbonation typically used the CO₂ in specific amounts because the user still wants to retain the use of the alkaline binder in the cement.

In an embodiment, the cement may be made from a neutral rock and an alkaline liquid. The neutral rock may be fully carbonated cement and the alkaline liquid or other liquid as required converts carbonates back to a binder (hydroxides). The two may be mixed together to create cement. The reaction may be as follows:

CaCO₃(s)+2NaOH(aq) [symbol] Ca(OH)₂(aq)+Na₂CO₃(aq).

Calcium hydroxide is a traditionally used binder in cement, but others may be used also.

Typically, cement does not start with carbonates. Because the users are carbonating the cement particle, the user may convert the calcium carbonates back to a binder (calcium hydroxide or others) while keeping the CO₂ trapped in the form of a bicarb or other form. The CO₂ trapped initially at the cement plant may stay trapped.

One embodiment of the current disclosure may provide a cement job which consist of approximately 100% carbonated cement with a specific amount of locked in CO₂ and then a water solution with sodium hydroxide is added, and heat or time also may be added. By doing so, the cement powder is neutralized once it has been sintered with waste cement plant CO₂ emissions, the user may then use (react) the carbonates in the cement powder to provide enough binder to harden the cement or concrete to specific conditions required. The embodiment may provide no chlorides and allow for control the pH of the final product.

In one embodiment of the disclosure, Portland cement class G is reacted with CO₂ in the presence of water (5%) to achieve a powder that has a pH=7.

Typically, non-carbonated cement (264 g) is mixed with 106 mL of pure water. The combination is stirred and then heated to 50° C. for 2 hours and let sit for an additional 2.5 hrs or other temperatures or times. This typically remains a liquid paste with no defined solid structure.

In an embodiment, instead of non-carbonated cement, the carbonated cement (264 g) is mixed with 106 mL of 0.7M NaOH solution. Where this combination is heated to 50° C. for 75 minutes or other times and temperatures, a solid is formed. The chemical reaction is CaCO₃+2 NaOH Ca(OH)₂+Na₂CO₃. The carbonated cement reacts with sodium hydroxide to give calcium hydroxide, which may be used as the binder in cement, and the CO₂ is transferred to the sodium carbonate. This provides no loss of the CO₂ to the environment in the cement and creates solid cement.

In one embodiment, the level of pH may be controlled, and the hardness and strength of the cement may be controlled by changing the amount of NaOH added. This cement may be stable in CO₂ atmospheres and may be marine safe.

There is a difference between the amount of water added to the cement example and the carbonated example. The difference in water amount occurs because the high pH cement may need to fully hydrate the calcium oxides into hydroxides that it needs more water in the initial mix.

Typically, cement's main binder is Ca(OH)₂, add water and the CaO becomes Ca(OH)₂. This combination starts to react (bind) with the silica particles and other particles, forming a solid.

In one embodiment of the disclosure, cement is partially reacted with CO₂, to get a material that will not form a solid, but if pure Ca(OH)₂ is added back in, the combination will turn into a solid.

If cement is fully carbonated, the cement becomes almost inert. The addition of Ca(OH)₂ to the cement assists with but is not enough to form a strong solid.

The nature of the fully carbonated cement is that most of the CaO and Ca(OH)₂ has turned into CaCO₃. With the reaction below which is called the Carbonate Causation reaction, which is an equilibrium reaction, the calcium may be converted from an inert species (calcium carbonate) to a reactive species (calcium hydroxide).

CaCO₃(s)+2NaOH(aq)=Ca(OH)₂(aq)+Na₂CO₃(aq)

Another reaction that creates calcium hydroxide is below and works quickly, again creating the hydroxide to act as a binder. Calcium chlorides are used in the cementing to accelerate the set of a concrete or cement.

CaCl₂+2NaOH→Ca(OH)₂+2 NaCl

One aspect about the causation reaction is the CO₂ is not released but stays trapped in the cement as the sodium carbonate.

So to summarize, a disclosed embodiment may take OPC, carbonate it fully and trap CO₂ emissions and gas into the cement, then react it with an alkaline solution to recreate the original cement and its binder system.

Adding other additives that are also carbonated may help. For example a carbonated cement slag and the slag is known to form a geopolymer with the addition of NaOH. But some slag in the fully carbonated cement with NaOH present does create a strong solid.

The more non CO₂ intensive additives in the cement, the better the cement or concrete may be from an environmental perspective. Some previous attempts disclose carbonating the additives but not the cement.

In one embodiment of the disclosure, the cement powder is reacted under an atmospheric pressure of CO₂ with 5% water added initially. The reaction may be cooled in a water bath, and after a period of time, for example 30 minutes, stop the flow of CO₂ and dry out the cement powder. To get a different PH of cement, for example PH of 7, once a period of time is up, for example 30 minutes, the cement may be removed from the water bath and additional water may be added, for example 10-20 ml. The semi reacted powder may then be mixed and flow a stream of CO₂ over the semi reacted powder, if the semi reacted powder dries more water is added until the pH of the powder reads 7 or a different selected value. The reaction may stop once the water evaporates because the heat of reaction, unless the reaction is cooled and the water retained. CO₂ may react with water to give carbonic acid which reacts with the cement particle.

In one embodiment, the reaction of CO₂ with the cement powder produces carbonates, predominantly calcium carbonates. More calcite, calcium carbonate, may be formed. When water is added to the cement, the calcium oxides become hydroxides and start binding other particles together. By carbonating the cement, the cement is effectively neutralized. To get the neutralized cement to bind again, either fresh Ca(OH)₂ is added or CaCO₃ is converted back to Ca(OH)₂. The level of addition depends on the amount of CO₂ added to neutralize the cement. Different cements may need less Ca(OH)₂ to get the cement to solidify.

In one embodiment, the cement does not have a high internal pH because only the required amount of Ca(OH)₂ is added to cause binding.

In one embodiment, if NaOH is used to convert the CaCO₃ to Ca(OH)₂, the CO₂ remains within the cement because the NaOH turns into Na₂CO₃. This may lead to a fully carbonated cement.

As referred to in FIG. 11, an embodiment is disclosed for producing an initial cementitious powder, comprising steps of providing a mixture of ground calcareous materials and ground argillaceous materials 30, heating the mixture to a temperature sufficient to calcine and fuse the ground materials to form a cement clinker 32, cooling the cement clinker 34, and grinding the cement clinker to produce the initial cementitious powder 36. In step 32 as described above, an exhaust gas containing CO₂ may be produced and optionally collected in step 38.

As shown in FIG. 10, an embodiment for producing carbonated cementitious material or carbonated Portland cement may comprise the steps of: in step 10, providing an initial cementitious powder, for example using the steps illustrated in FIG. 11 above; in step 12, combining the initial cementitious powder with water, for example in the form of water vapor, mist, or stream; in step 14, supplying carbon dioxide to the powder, which may optionally be supplied at atmospheric pressure, and mechanically stirring, where the carbon dioxide may optionally be carbon dioxide collected in step 38, to cause a reaction of the carbon dioxide with the moistened cementitious powder to produce a fully or partially carbonated cementitious powder, wherein different levels of CO₂ in the gas produce different levels of carbonation in the cementitious powder; in step 16, the reaction may optionally be cooled; in step 18, the reaction may optionally be monitored through various means, for example by pH, to determine if additional CO₂ or water should be added; in step 20, the fully or partially carbonated cementitious material or carbonated cement clinker may be dried and ground.

In one embodiment, cementitious compositions are provided that can be used in drilling oil and gas well applications. The compositions include a source of hydraulically settable cement, and a carbonated cement. The amount of carbonated cement controls the alkalinity in the cement. Other ingredients include hydrated lime, alkali ions, calcium sulfate, calcium chlorides and an organic component. These ingredients are used to quicken or retard set times, smooth out the blend and a quick setting cement. Methods for cementing a casing and liners and for remedial operations such as plugging back, and squeeze cementing are also provided. Methods for producing a low alkaline cement suitable for high CO₂ gas wells are also provided.

In one embodiment, carbonates are converted in situ into hydroxides and recreate the binder removed when CO₂ is added to the cement. Chemicals other than sodium hydroxide may be used.

In one embodiment at 20° C. everything takes longer to solidify but at 50° C. some combinations of cement behave normally. None of the additives seem to help and at 80° C. they seem to hinder the cement from forming a solid matrix.

The addition of CO₂ to cement may slow the initial strength development of the cement but with added time or heat, the cement9 develops strength and traps and mineralizes CO₂.

Cement may become a hard rock primarily because of the hydration of lime oxide.

CaO+H₂O→Ca(OH)₂

The calcium hydroxide is a binder in cement. When CO₂ and water are added to cement, an acid/base reaction occurs.

CO₂+H₂O→H₂CO₃

Then the newly formed acid reacts with the basic cement.

H₂CO₃+Ca(OH)₂→CaCO₃+2H₂O

The binder may be replaced with a carbonate, the ability for the cement to harden may diminish depending on how much carbonation was done.

One way to increase Ca(OH)₂ levels in a carbonated cement is to add Ca(OH)₂ back into the cement.

Another way is to add NaOH to the carbonated cement. This has two benefits, first is creates Ca(OH)₂ and the second, it retains the trapped CO₂.

2NaOH+CaCO₃=Na₂CO₃+Ca(OH)₂

Since the reaction is reversible, it favors the creation of the calcium hydroxide because it is used up as a binder in the cement and the sodium carbonate is trapped in the cement matrix.

Another way is to use iron. Iron may be used in different forms to create in situ Ca(OH)₂. One form is FeCl₃ (Iron (III) chloride) a yellow cement. FeCl₃ when added to water creates HCl (an acid) immediately.

2FeCl₃+6H₂O→2Fe(OH)₃+6HCl

The HCl then reacts with the carbonated cement (a base), observed by a vigorous bubbling of the cement mixture.

6HCl+3CaCO₃→3CaCl₂+3H₂O+3CO₂

The combined reaction creates iron hydroxide and calcium chloride and gives off CO₂.

2FeCl₃+3H₂O+3CaCO₃→2Fe(OH)₃+3CaCl₂+3CO₂

The products of the above reaction create the calcium binder.

2Fe(OH)₃+3CaCl₂=3Ca(OH)₂+2FeCl₃

This is a reversable reaction but since the calcium hydroxide binder is used up, the reaction primarily goes in one direction from left to right. The iron chloride formed, colors the cement yellow. This method does not trap carbon dioxide as it releases the carbon dioxide back to the atmosphere.

Another form of iron is Fe(OH)₃ (Iron hydroxide) a white cement.

Iron chloride will react with NaOH faster than water, this creates iron hydroxide and salt.

FeCl₃+3NaOH→Fe(OH)₃+3NaCl

Iron hydroxide reacts with calcium carbonate to form the calcium binder.

2Fe(OH)₃+3CaCO₃→Fe₂(CO₃)₂+3 Ca(OH)2

The iron has trapped the CO₂ and is now white.

Similar to adding calcium hydroxide as a binder, MgO works best with cement that does not have a lot of free Ca(OH)₂. A carbonated cement would have little free Ca(OH)₂. MgO expands as it hydrates, this binder causes the cement to retain its original volume, avoiding shrinkage and cracking that the calcium-based binders are prone to.

MgO+H₂O→Mg(OH)₂

In one embodiment, the chemical reaction is as follows; carbon dioxide in the presence of water is converted into carbonic acid, carbonic acid reacts with calcium oxide to afford calcium carbonate. In this reaction the calcium oxide is present on the surface of the cement particle and is coated by a small amount of water, which absorbs the carbon dioxide gas in the surrounding atmosphere.

The carbonated cement may be made by adding dry OWG (also defined as OPC-G which is OPC class G per API spec 10A) into a container under an atmospheric blanket of carbon dioxide. Mechanical stirring is necessary to mix the cement powder, gas and water within the mixing container. Pressure is not needed as the carbon dioxide is heavier than air, just a constant flow of carbon dioxide into the container. Water (<5%) is added either slowly or all at once. The water can be added in as a mist or a stream. The mixture is stirred for 30 minutes to 3 hours to obtain a wet powder that, when placed into water, yields a pH of between 7-10. OWG has a pH of 13. The reaction is exothermic, and a cooling jacket is used to disperse the heat that is generated from the acid-base reaction. Because the reaction of CO₂ with the cement is exothermic the heat will promote evaporation of the water. If the water is evaporated at any time during the mixing process the reaction also stops, additional water can be added at this point to keep the carbonation reaction going until the desired pH is reached. Once the desired pH has been reached, the container is opened and air is allowed into the reaction vessel stopping the carbonation reaction, residual heat will drive off any remaining water into the atmosphere and dry the carbonated cement. A dry product is useful for storage. Stirring during the drying stage will help dry the cement off more efficiently.

The carbonated cement can be controlled by limiting the water or the amount of carbon dioxide that is fed into the reactor. The cement powder may partially set during this process especially at higher temperatures. Some grinding may be necessary. Depending on the amount of carbonation needed, the cement can be carbonated in a range of 10 g per kg of cement to 320 g per kg of cement or 1 kg to 32 kg of carbon dioxide per 1000 kg of concrete. (Concrete has 10% cement in it). These numbers are based on the quantity of carbon dioxide and water used in the above reaction but are controlled by the conditions of the reaction; mixing, water, carbon dioxide gas flow and air flow. Steinor's formula provides a theoretical maximum carbonation of cement G.

The maximum theoretical amount, Steinor's formula,

CO₂%=0.785(CaO)+1.091(MgO)+1.41(Na₂O)+0.935(K₂O)−0.55(SO₃)

For OWG this theoretical maximum is 550 g of carbon dioxide/kg of OWG. A report on recycled cement pastes from concrete (“Carbon Capture and Utilization by mineralization of cement pastes derived from recycled concrete”, Scientific Reports, Skocek et al.), indicates that they obtained a result of 420 g of carbon dioxide/kg of cement when adding CO₂ to the cement pastes at 8 bar pressure.

Based on the above calculations, OPC may be carbonated to varying degrees using this method. Cement may also be made with a specific amount of carbon dioxide mineralized in the final product to be used in various commercial settings, depending on the desired mass of mineralized carbon need for the application.

Studies estimate that between 33-57% of the carbon dioxide emitted from the calcination of cement will be reabsorbed through carbonation of concrete surfaces over a 100-year life cycle. This happens as the carbon dioxide is absorbed back into the alkaline concrete matrix and reacts with free calcium oxide and hydroxide molecules, in the concrete. In most cases, cement when it is made has more reactivity than the application requires. This leaves the concrete form vulnerable to environmental effects. By carbonating the cement before it is used, these environmental effects can be lessened or eliminated.

An example of this would be concrete used in marine environments where conventional concrete forms have an elevated pH (12-13) which over time will approach that of seawater (8.3) but initially that high pH will kill off marine life as it leeches into the ocean. Marine concrete reefs are typically weathered over years on surface before being put into the ocean. Another example would be cement used to seal off high carbon dioxide formations or underground storage areas. The high pH cement has a tendency to react overtime with the low pH, carbonic acid, made by the reaction of water and carbon dioxide.

In an embodiment, the method minimizes the available calcium source so that the carbon dioxide cannot react inside the cement. If the cement is pre-carbonated before use this would minimize the reactivity of the cement to external carbon dioxide and water sources. One aspect of the method is quickening the process aging by balancing out the reactivity of the cement clinker to better mimic its environment. This would have the effect of extending the life of the concrete form because the more pre-weathered the concrete/cement is, the less environmental intrusion into the concrete there will be, the less spalling, cracking and disintegration will occur.

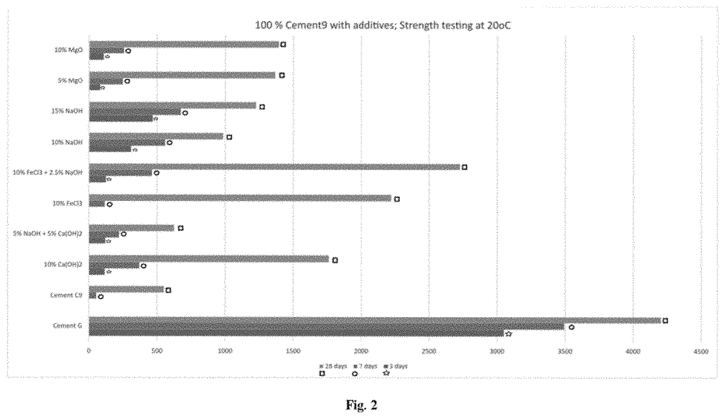

In one possible embodiment, the carbonation of free calcium oxides in cement clinker effects the binding capacity of the cement and ultimately the compressive strength of the resulting form. When hydrating the carbonated cement at 20° C., the carbonated cement needs some additional binders to replace those that have been carbonated. As can be seen from FIG. 2, after 3 days the compressive strength of the carbonated cement (C9) is lower compared to non-carbonated cement (Cement G, which is also defined herein as OWG or OPC-G). In FIG. 2, the compressive strength of cement is shown on the bottom horizontal axis in a range of 0-4500 psi. Even with the additional added binders, the compressive strength is better but nowhere near that of untreated cement. Over time, the binders added; Ca(OH)₂, NaOH, FeCl₃ and MgO all started to replace the deactivated binders on the cement clinker but there was never a real recovery of the compressive strength observed in the non-carbonated cement powder. Of the four binders used two, (Ca(OH)₂ and MgO) are replacing deactivated carbonated calcium binders and two, (FeCl₃ and NaOH) are reactivating the carbonated binders. The reactivation removes the carbon dioxide from the calcium and makes the calcium reactive again by eventually turning the calcium into a reactive hydroxide form. The binder that had the most success was the FeCl₃ and NaOH, the conversion of FeCl₃ into Fe(OH)₃ (the binder) and then the subsequent reaction with the carbonated cement took time but eventually started to improve the carbonated cement's compressive strength to close to that of the non-carbonated cement.

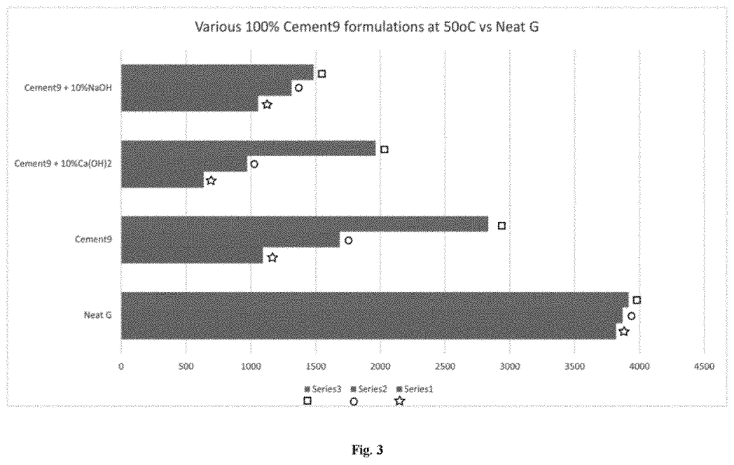

FIG. 3 shows the compressive strengths of the various cement formulations at 50 deg. C. The horizontal scale shows a scale of 0-4500 psi.

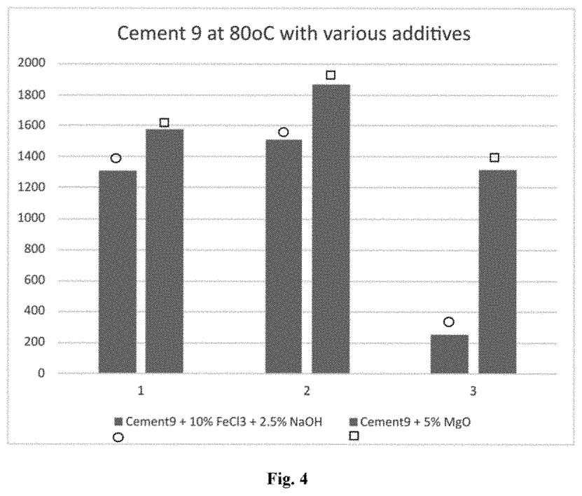

FIG. 4 shows the compressive strengths of the various cement formulations at 80 deg. C. The vertical axis shows a scale of 0-2000 psi.

Heat may be a requirement of most chemical reactions, since the carbonation of cement is exothermic, heat may be required to reverse this process. Simply heating the same binders in carbonated cement for 1 hour at 50° C. gave different results ranging from 2100 to 7000 psi after 28 days at room temperature. After 3 days, the untreated cement has only really improved by roughly 20% to 3800 psi. Whereas the carbonated cement went from a strength in psi of 0 to 1100. The added binders NaOH and Ca(OH)₂ had respective increases in strength of 6 and 3 times. The binders Fe(OH)₃ (reacted product of FeCl₃ and NaOH) and MgO were added to the carbonated cement and placed in a water bath at 80° C. Both MgO and Fe(OH)₃ need additional heat to accelerate their reactivity with the carbonated cement. After 3 days both samples show elevated strength tests of 20 and 10 times the strength tests done at 20° C.

Table 1 is a table showing the compressive strength (stress attained before failure) of various mixes of cements after the cement solidified over 28 days.

TABLE 1

| C9 with 5% OWG | psi after 28 days |
|---|---|
| No additives | 1730 |
| 10% Ca(OH)2 | 1321 |
| 5% Ca(OH)2 + 5% NaOH | 851 |
| 10% NaOH | 772 |
| 15% NaOH | 814 |

All samples were heated for 1 hour at 50° C.
and then left at room temperature
Samples were submerged in water for 28 days

| | |
|---|---|
| Conclusion | Straight OWG and |
| | Cement 9 was the |
| | best cement after curing |

Table 2 is a table showing the compressive strength of various mixes of cements after the cement solidified over a number of days at 25 deg. C.

TABLE 2

| Curing: | Addi- | 3 Days (CS, psi) | | | | 7 days (CS, psi) | | | | 28 days (CS, psi) | | | |
|---|---|---|---|---|---|---|---|---|---|---|---|---|---|
| 25° C. | tives | #1 | #2 | #3 | Avg | #1 | #2 | #3 | Avg | #1 | #2 | #3 | Avg |
| OWG | N/A | 3700 | 2761 | 2691 | 3051 | 3127 | 3830 | 3519 | 3492 | 5219 | 3192 | | 4206 |
| Cement 9 | N/A | 0 | 0 | 0 | 0 | 55 | 48 | 53 | 52 | 567 | 534 | | 551 |
| | 10% | 110 | 114 | 119 | 114 | 368 | 372 | 373 | 371 | 1911 | 1699 | 1672 | 1761 |
| | Ca(OH)2 | | | | | | | | | | | | |
| | 5% | 132 | 121 | 107 | 120 | 206 | 235 | N/A | 220.5 | 674 | 571 | | 623 |
| | NaOH + | | | | | | | | | | | | |
| | 5% | | | | | | | | | | | | |
| | Ca(OH)2 | | | | | | | | | | | | |
| | 10% | 0 | 0 | 0 | 0 | 111 | 122 | N/A | 116.5 | 1974 | 2468 | | 2221 |
| | FeCl3 | | | | | | | | | | | | |
| | 10% | 131 | 130 | 110 | 124 | 533 | 576 | 281 | 463 | 2978 | 2244 | 2959 | 2727 |
| | FeCl3 + | | | | | | | | | | | | |
| | 2.5% | | | | | | | | | | | | |
| | NaOH | | | | | | | | | | | | |
| | 10% | 250 | 463 | 205 | 306 | 538 | 580 | N/A | 559 | 937 | 1036 | | 987 |
| | NaOH | | | | | | | | | | | | |
| | 15% | 429 | 526 | 446 | 467 | 671 | 674 | N/A | 672.5 | 1225 | | | 1225 |
| | NaOH | | | | | | | | | | | | |
| | 5% | 82 | 74 | 84 | 80 | 254 | 271 | 215 | 247 | 1398 | 1321 | | 1360 |
| | MgO | | | | | | | | | | | | |
| | 10% | 105 | 103 | 106 | 105 | 297 | 252 | 220 | 256 | 1389 | 1399 | | 1394 |
| | MgO | | | | | | | | | | | | |

Comment
Moulds prepared on Jul. 12 and 13, 2021

Table 3 is a table showing the compressive strength of various mixes of cements after the cement solidified over a number of days at 52 deg. C.

TABLE 3

| Curing: | Addi- | 3 Days (CS, psi) | | | | 7 days (CS, psi) | | | | 28 days (CS, psi) | | | |
|---|---|---|---|---|---|---|---|---|---|---|---|---|---|
| 52° C. | tives | #1 | #2 | #3 | Avg | #1 | #2 | #3 | Avg | #1 | #2 | #3 | Avg |
| OWG | N/A | 4068 | 3568 | | 3818 | 4205 | 3533 | | 3869 | 3869 | 3400 | | 3634.5 |
| Cement | N/A | 979 | 1204 | | 1092 | 1756 | 1612 | | 1684 | 3096 | 2571 | | 2833.5 |
| 9 | 10% | 650 | 621 | | 636 | 1022 | 920 | | 971 | 1707 | 2221 | | 1964 |
| | Ca(OH)2 | | | | | | | | | | | | |
| | 5% | 544 | 529 | | 537 | 769 | 772 | | 770.5 | 1067 | 1001 | | 1034 |
| | NaOH + | | | | | | | | | | | | |
| | 5% | | | | | | | | | | | | |
| | Ca(OH)2 | | | | | | | | | | | | |
| | 10% | 1361 | 1562 | | 1462 | 2419 | 2051 | | 2235 | 2547 | 2792 | | 2669.5 |
| | FeCl3 | | | | | | | | | | | | |
| | 10% | | | | | | | | | | | | |
| | FeCl3 + | 2076 | 2052 | | 2064 | 3475 | 4041 | | 3758 | 2690 | 3406 | | 3048 |
| | 2.5% | | | | | | | | | | | | |
| | NaOH | | | | | | | | | | | | |
| | 10% | 1159 | 951 | | 1055 | 1262 | 1364 | | 1313 | 1432 | 1533 | | 1482.5 |
| | NaOH | | | | | | | | | | | | |
| | 15% | 696 | 846 | | 771 | 866 | 739 | | 802.5 | 1305 | 1171 | 1082 | 1186 |
| | NaOH | | | | | | | | | | | | |
| | 5% MgO | 2377 | 2414 | | 2396 | 2566 | 2852 | | 2709 | | | | |
| | 10% | 1464 | 1638 | 1827 | 1643 | 3104 | 2893 | 2965 | 2987 | | | | |
| | MgO | | | | | | | | | | | | |

Comment: Moulds prepared on

Table 4 is a table showing the compressive strength of various mixes of cements after the cement solidified over a number of days at 80 deg. C.

TABLE 4

| Curing: | Addi- | 3 Days (CS, psi) | | | | 7 days (CS, psi) | | | | 28 days (CS, psi) | | | |
|---|---|---|---|---|---|---|---|---|---|---|---|---|---|
| 80° C. | tives | #1 | #2 | #3 | Avg | #1 | #2 | #3 | Avg | #1 | #2 | #3 | Avg |
| OWG | N/A | 3318 | 2381 | | 2850 | 2453 | 3448 | | 2950.5 | 2833 | 3083 | | 2958 |
| Cement 9 | N/A | 2493 | 2212 | | 2353 | 2452 | 2388 | | 2420 | 2469 | 2187 | | 2328 |
| | 10% | 2329 | 2907 | | 2618 | 2373 | 2829 | | 2601 | 2399 | 2350 | | 2374.5 |
| | Ca(OH)2 | | | | | | | | | | | | |
| | 5% | 510 | 555 | | 533 | 729 | 691 | | 710 | 860 | 823 | | 841.5 |
| | NaOH + | | | | | | | | | | | | |
| | 5% | | | | | | | | | | | | |
| | Ca(OH)2 | | | | | | | | | | | | |
| | 10% | 1506 | 1119 | | 1313 | 1438 | 1579 | | 1508.5 | 258 | 258 | | 258 |
| | FeCl3 | | | | | | | | | | | | |
| | 10% | 1715 | 1552 | | 1634 | 1238 | 1308 | | 1273 | | | | |
| | FeCl3 + | | | | | | | | | | | | |
| | 2.5% | | | | | | | | | | | | |
| | NaOH | | | | | | | | | | | | |
| | 10% | 1372 | 1051 | | 1212 | 1628 | 1202 | | 1415 | | | | |
| | NaOH | | | | | | | | | | | | |
| | 15% | 1323 | 963 | | 1143 | 1187 | 1377 | | 1282 | | | | |
| | NaOH | | | | | | | | | | | | |
| | 5% MgO | 2312 | 2395 | 2618 | 2441 | 3066 | 3516 | 2399 | 2993 | | | | |
| | 10% MgO | 1568 | 1582 | | 1575 | 2179 | 1557 | | 1868 | 1338 | 1300 | | 1319 |

Comment: Moulds prepared on Aug. 13, 2021

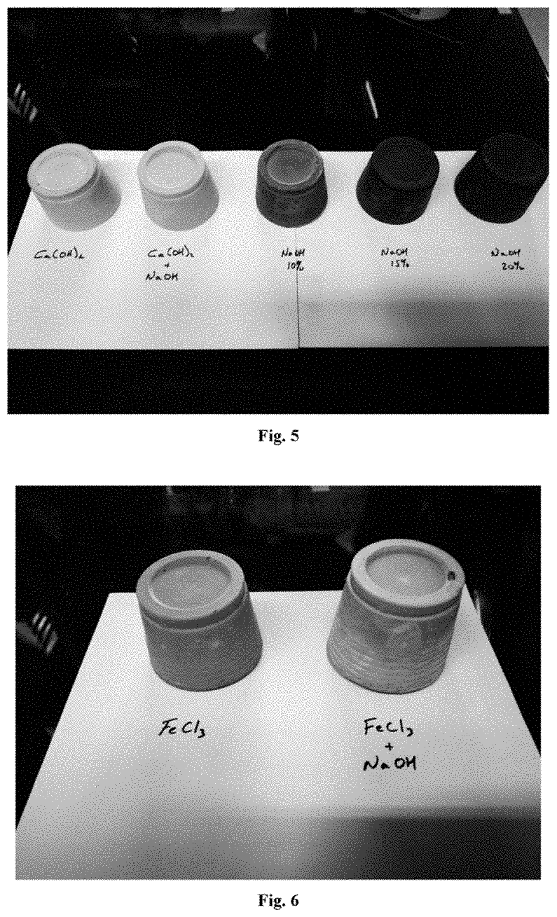

The various binders added to the carbonated cement also produce various colors of cement. The colors are shown in FIGS. 5-7 and are described herein as follows:

FIG. 5 is an image showing different colors of various cement mixes after solidification. The colors of the samples are white with light grey inclusions on the left, white on the second from the left, brown in the center, dark brownish-black on the second from the right, and nearly black on the right.

FIG. 6 is an image showing different colors of various cement mixes including iron chloride after solidification. The colors are dark yellow on the left sample and light brownish yellow with white throughout on the right sample.

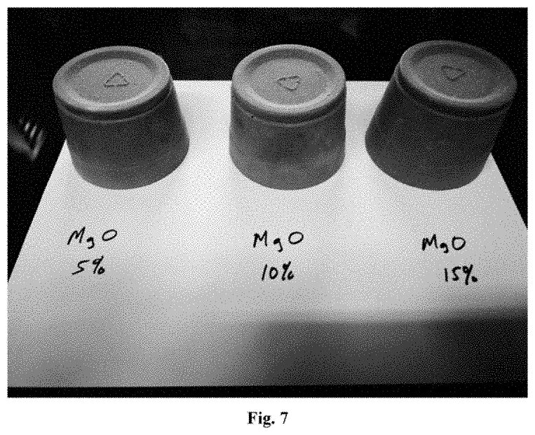

FIG. 7 is an image showing different colors of various cement mixes including magnesium oxide after solidification. The colors of the samples are various shades of brown with white throughout.

An exemplary method of use for the carbonated cementitious materials and compositions is disclosed. Cementitious compositions are provided that may be used in cementing oil and gas well applications. The compositions include a source of hydraulically settable cement, ordinary Portland Cement (OPC) and carbonated OPC, a carbonated cementitious powder. To control the reaction processes to render the compositions suitable for well cementing, various additives such as retarders, accelerators and extenders may be added. For example, the accelerators may include CaCL2, Sodium metasilicate, NaCl, CaO, Ca(OH)2. For example, the extenders may include bentonite, and clay type materials. Carbonated OPC acts as a retarder. Carbonated OPC retards the reaction speed in the cement mixture while contributing to the overall strength of the hardened mixture. Other ingredients in a typical cement operation may include hydrated lime, alkali ions, calcium sulfate, calcium chlorides and an organic component. Methods for cementing casing, liners and remedial operations such as plugging back, and squeeze cementing are also provided. Methods for producing a low alkaline cement suitable for high CO₂ gas wells are also provided. Methods to achieve a stable retarded cement used in higher temperature applications is also provided. The high temperature applications may be within a range of 80 deg. C to 150 deg. C.

Environmentally friendly cement products may reduce the amount of CO₂ or other undesirable pollutants and/or waste products and/or energy consumption while still producing comparable performance. It is desirable to produce various Portland cement products that have a reduced environmental impact during manufacture. A cementitious product for various applications, such as oil and gas well applications, which reduces energy consumption and potential environmental impact would be highly desirable. In this regard, it is desirable to develop environmentally friendly cement products that provide comparable or enhanced performance when compared to traditional cement products.

In various aspects, a cementitious composition for oil and gas well applications is provided. In one aspect, a carbonated cementitious composition comprises a carbonated OPC, a hydraulic cement, a source of various retarders, a source of various accelerators, a source of dispersants and other ingredients needed for the successful placement of the carbonated cement in the oil and gas well bore. A binder may also be added to help increase the strength of the cement.

In an embodiment, OPC is subjected to an atmosphere of water and CO₂, under controlled conditions that allow for the partial carbonation of OPC. The carbonated cement may be mixed with OPC in ratios from 0-100%, depending on the speed of the set time required for the specific application. The addition of CO₂ to OPC slows down the reactivity of the OPC by the conversion of calcium oxides to calcium carbonates. For oil and gas operations, a certain set time and strength is preferred to carry out a successful wellbore cementing operation.

When CO₂ is added to OPC it is mineralized and trapped as a carbonate, the amount of mineralization depends on the amount of CO₂ added to the OPC which can vary from 1 g to 32 g per 100 g of OPC clinker. The carbonation process may start with the addition of CO₂ to water which creates carbonic acid, this acid then reacts with alkaline sites on the OPC, namely calcium oxide to create calcium carbonate.

As the proportion of calcium oxide sites on the OPC particle decreases through carbonation, the reactivity of the carbonated particle decreases. Carbonation occurs on the surface of the OPC particle and renders the calcium oxide inert to any further chemical reactions. As water is added to the carbonated OPC particle, the hydration works to create new calcium oxide sites, which can participate in the binding of other OPC particles. Heat accelerates the hydration process, so under higher temperatures the carbonated OPC while slower to react, will eventually set once sufficient hydration has occurred on the surface of the OPC particle. Carbonated cement mixtures with OPC can retard the setting times as hydration of the OPC particle takes time to react.

A common blend of wellbore cement is a mix of fly ash, OPC and water. The ratio of fly ash to OPC influences the final density of the cement paste used in a wellbore application. In an example, a wellbore cement with a density of 1700 kg/m3 was chosen. A blend of 65% fly ash and 35% OPC is used for the solid content and the remainder is water to give a final density of 1700 kg/m3. This blend gives an ultimate compressive strength of 18 MPa.

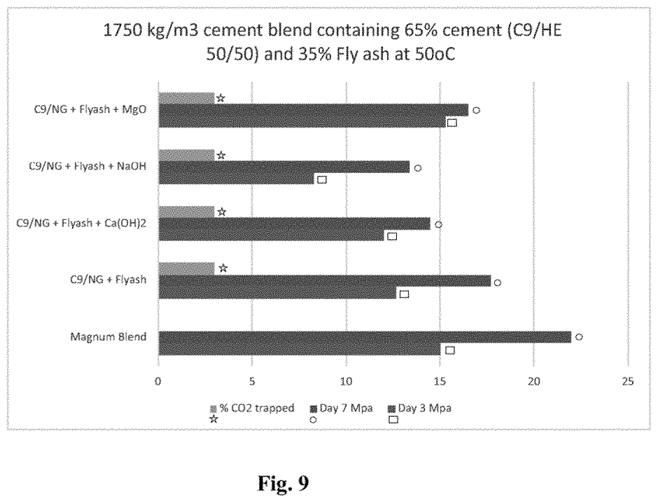

Various additives used to accelerate the cement reaction were also tested with the compressive strengths, tested after 3 and 7 days. The results are shown in FIG. 9.

In addition to an increase in compressive strength there is 3% by wt. of CO₂ in the prepared cement paste that is mineralized and tied up once the hardened cement sets.

Cement density=1400 kg/m3 for formulation using carbonated cement

TABLE 5

| | | | PC Wt | PC TT | | | |
|---|---|---|---|---|---|---|---|
| Temp | | | 40 Bc | 70 BC | Compressive Str (Mpa) | | |
| (° C.) | Retarder % | C9 % | (hr:min) | (hr:min) | 8 hr | 12 hr | 24 hr |
| 25 | 0 | 0 | 3:40 | 4:00 | 1.2 | 1.8 | 2.6 |
| | 0 | 50 | 7:45 | 10:00 | 0.3 | 0.8 | 1.5 |
| 50 | 0.3 | 0 | 3:10 | 3:53 | 1 | 1.2 | 2 |
| | 0.3 | 50 | 17+ | | | | |
| | 0 | 50 | 4:30 | 6:00 | 0.7 | 1 | 1.8 |
| 70 | 0.45 | 0 | 4:00 | 4:20 | 0.9 | 2.2 | 6.5 |
| | 0 | 50 | 2:00 | 3:00 | 1.4 | 2.7 | 5.3 |
| 90 | 0.6 | 0 | 4:50 | 5:15 | 0.1 | 0.1 | 4.7 |
| | 0.3 | 50 | 3:10 | 3:30 | 2.5 | 3.8 | 4.6 |
| 110 | 0.5 | 0 | 2:48 | 3:00 | 5.0 | 6.1 | 6.8 |
| | 0.4 | 50 | 3:00 | 4:30 | 4.5 | 5.6 | 6.5 |

For example, Table 5 above shows at 90 deg. C, with 0.3% retarder, 50% C9, and 49.7% OPC, the pressured consistometer working time (PC WT) is 3 hours and 10 minutes.

Cement density=1650 kg/m3 formulation using carbonated cement

TABLE 6

| Temp | Retar- | | PC WT | PC TT | Compressive Str Mpa | | |
|---|---|---|---|---|---|---|---|
| (° C.) | der % | C9 % | (hr:min) | (hr:min) | 8 hr | 12 hr | 24 hr |
| 25 | 0 | 0 | 2:15 | 3:00 | 5.90 | 8.10 | 11.70 |
| | 0 | 50 | 5:23 | 8:06 | 1.70 | 3.00 | 6.20 |
| 50 | 0.1 | 0 | 2:24 | 2:50 | 7.3 | 10.10 | 13.00 |
| | 0.1 | 50 | 7:09 | 7:44 | 1.00 | 3.80 | 6.90 |
| | 0 | 50 | 2:00 | 2:00 | 4.10 | 5.20 | 7.60 |
| 70 | 0.15 | 0 | 2:50 | 4:30 | 5.30 | 9.20 | 20.20 |
| | 0.15 | 50 | 12:54 | 13:27 | 0.10 | 0.10 | 6.40 |
| | 0 | 50 | 1:01 | 1:20 | 4.70 | 10.10 | 18.80 |
| | 0.05 | 50 | 2:26 | 2:52 | 3.00 | 5.40 | 17.20 |
| 90 | 0.3 | 0 | 8:15 | 8:18 | 0.00 | 0.00 | 0.00 |
| | 0.1 | 50 | 6:55 | 7:10 | 0.10 | 1.30 | 16.50 |

More specific tests done with two blends (1400 and 1650 kg/m3) at different temperatures show that at low temperatures the working time is significantly retarded, but as the temperature climbs past 50° C. the working time is close to, if not faster than a typical retarded cement. If retarder is used in conjunction with the carbonated cement, a longer working time is observed when compared to a normal cement blend using the same amount of retarder. Examples of retarders that may be used are sugar, tartaric acid, lignosulfonate, cellulose derivatives and phosphonates. When the temperature was increased to 90° C., the carbonated cement mixture with a reduced amount of retarder performs better than the regular cement blend, in that it gives a better working time and develops a better compressive strength within 24 hrs.

TABLE 7
Comparison of OPC cement blend 1650 kg/m3, to a 50/50 mix of OPC/C9 and OPC/C7

| | | Retarder | PC WT | PC TT | Compressive Strength (MPa) | | | |
|---|---|---|---|---|---|---|---|---|
| Temp | | % of total | 40 Bc | 70 Bc | | | | Time to 3.5 |
| (° C.) | Blend | weight | (hr:min) | (hr:min) | 8 hr | 12 hr | 24 hr | MPa (hr:min) |
| 110 | OPC 1650 | 0.40 | 2:57 | 3:03 | 0.0 | 6.1 | 16.8 | 10:44 |
| | kg/m3 | | | | | | | |
| | 50/50 mix | 0.15 | 3:40 | 3:42 | 6.3 | 9.6 | 14.8 | 5:54 |
| | OPC/C9 | | | | | | | |
| | 50/50 mix | 0.15 | 4:17 | 4:20 | 11.0 | 12.2 | | 5:03 |
| | OPC/C7 | | | | | | | |

For example, in the table above, the OPC 1650 dg/m3, with 0.4% by total weight retarder, has a 2 hour and 57 minute Pressured Consistometer Working Time (PC WT) and a 3 hour and 3 minute Pressured Consistometer Thickening Time (PC TT).

Another example of the retarding effect of the carbonated cement. In Table 7, a comparison at a temperature of 110° C., with blends of a 1650 kg/m3 density cement, using C7 (a 30% CO₂ carbonated OPC cement) and C9 (6% CO2 carbonated OPC cement) were mixed 50/50 with OPC cement and compared to 100% OPC cement. As shown, the carbonated cement blends perform better than the 100% OPC blend. Using less retarder in the carbonated blends, gets more retarding effects for working time but an increase in early strength development. What is evident is that the retarding effect of the carbonation on working time is reversed when looking at the compressive strength. The compressive strength for the cement blends using traditional chemical retarders working at high temperature slow the working time down but also slow the strength development of the cement blend too.

A percentage balance between carbonated and non-carbonated cement may be used at various wellbore temperatures to achieve the proper working time and compressive strength desired for that application.

As the temperature climbs in wellbore applications pass 80° C., traditional lower temperature retarders start to behave erratically, and high temperature retarders need to be used. The problem below 120° C. is that the high temperature retarders work too well and working times are extended too long, with the cement potentially never setting in these types of applications.

Carbonated cement overcomes these temperature restrictions. The carbonation of cement affects the readily available calcium oxide sites on the cement particle, this has the effect of slowing down the rate of reactivity of the cement binding process but not eliminating it. As higher temperatures increase the rate of reactivity, the other calcium oxide sites that are not carbonated start to come into play and contribute to the overall strength obtained when the cement hardens.

Although the carbonated cement particle is retarded, it is not retarded in a traditional way typical retarders are known to work by. There are several potential retarding methods: 1. Adsorption theory: The retarder adsorbs onto the surfaces of the hydration products, thereby inhibiting contact with water. 2. Precipitation theory: The retarder reacts with calcium ions, hydroxyl ions, or both in the aqueous phase, forming an insoluble and impermeable layer around the cement grains. 3. Nucleation theory: The retarder adsorbs onto the nuclei of hydration products, arresting their future growth. 4. Complexation theory: The retarder chelates the calcium ions, preventing the formation of nuclei. It is probable that all the above theories are involved to some extent in the retardation process, (Well Cementing, 2^{nd} edition; Eric B. Nelson)

Most chemical retarders are large molecular weight molecules, they work to block the hydration process occurring on the cement particles. With carbon dioxide, the retarding mechanism is the irreversible removal of active hydration sites on the surface of the cement particle but because there are many active sites on a cement particle, thermal energy will activate the hard-to-reach sites to allow proper binding of the cement particles. This allows for a stable, reliable retarding action when using carbonated cement at increasingly higher temperatures.

The methods of the present invention are useful in completing wells, such as for example oil and/or gas wells, water wells, geothermal wells, acid gas wells, carbon dioxide injection, production wells and ordinary wells. Placement of the carbonated cementitious composition in the portion of the wellbore to be completed is accomplished by means that are known in the art of wellbore cementing.

The carbonated cementitious composition may be placed in a subterranean wellbore surrounding a casing to prevent vertical communication through the annulus between the casing and the wellbore or the casing and a larger casing. The carbonated cementitious suspension may be placed in a wellbore by circulation of the suspension down the inside of the casing, followed by a wiper plug and a non setting displacement fluid. The wiper plug is usually displaced to a collar, located near the bottom of the casing. The collar catches the wiper plug to prevent over displacement of the carbonated cementitious composition and also minimizes the amount of the carbonated cementitious composition left in the casing. The carbonated cementitious suspension is circulated up the annulus surrounding the casing, where it is allowed to harden. The annulus could be between the casing and a larger casing or could be between the casing and the subterranean borehole. As in regular well cementing operations, such cementing operations with a carbonated cementitious suspension may cover only a portion of the open hole, or more typically up to a point inside the next larger casing or sometimes up to the surface. This method has been described for completion between formation and a casing, but can be used in any type of completion, for example with a liner, a slotted liner, a perforated tubular, an expandable tubular, a permeable tube and/or tube or tubing.

In the same way, the methods of the present invention are useful in completing or for use in a well, such as for example oil and/or gas well, water well, geothermal well, acid gas well, carbon dioxide well and ordinary well, wherein placement of the carbonated cementitious composition in the portion of the wellbore to be completed is accomplished by means that are well known in the art of wellbore reverse circulation cementing.

The carbonated cementitious composition can also be used in squeeze job and/or in remedial job. The carbonated cementitious material is forced through perforations or openings in the casing, whether these perforations or openings are made intentionally or not to the formation and wellbore surrounding the casing to be repaired. Carbonated cementitious material is placed in this manner to repair and seal poorly isolated wells, for example, when either the original cement material fails, or was not initially placed acceptably, or when a producing interval has to be shut off.

The carbonated cementitious composition can also be used in abandonment and/or plugging job. The carbonated cementitious material is used as a plug to shut off partially or totally a zone of the well. Carbonated cementitious material plug is placed inside the well by means that are well known in the art of wellbore plug cementing.

According to other embodiments of the invention, the methods of completion described above can be used in combination with conventional cement completion.

The carbonated cement has a reduced alkalinity. When set at higher temperatures, i.e., deeper hotter wellbores, the reduced alkalinity has the effect of reducing the long term reactivity of the cement towards external chemical attack. This trait would be beneficial for use in subterranean formations containing CO2 as wells set with normal cement are subjected to chemical attack by carbonic acid because of the high alkalinity of normal cement. Carbonated cement has a reduce alkalinity and hence more stability when surrounded by carbonic acid.

Where OPC is referred to in the application, any class or type of OPC known in industry may be used, including classes A-H per API Spec 10A; types I to V per ASTM 150; CEM I to V per EN 197 Norm; GU, GUL, MS, MH, MHL, HE, HEL, LH, LHL, or HS per CSA A3000/A3001; or GU, HE, MS, HS, MH, LH per ASTM C1157.

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method of carbonating cement powder, the method comprising:
providing an initial cementitious powder;
supplying an amount of water to the initial cementitious powder to create a moistened cementitious powder;
supplying carbon dioxide to the moistened cementitious powder, while mechanically stirring the moistened cementitious powder, to cause a reaction of the carbon dioxide with the moistened cementitious powder to produce a fully or partially carbonated cementitious material; and
drying and grinding the fully or partially carbonated cementitious material to produce a fully or partially carbonated cementitious powder.

2. The method of claim 1 in which the amount of water added to the initial cementitious powder is less than 5% by weight of the initial cementitious powder.

3. The method of claim 1 comprising controlling the reaction of the carbon dioxide with the moistened cementitious powder, the fully or partially carbonated cementitious material being a partially carbonated cementitious material and the fully or partially carbonated cementitious powder being a partially carbonated cementitious powder.

4. The method of claim 3 in which the control of the reaction of the carbon dioxide with the moistened cementitious powder comprises controlling the amount of water.

5. The method of claim 3 in which the control of the reaction of the carbon dioxide with the moistened cementitious powder comprises monitoring a pH of the moistened cementitious powder and controlling the reaction according to the monitored PH.

6. The method of claim 1 in which the amount of water is supplied to the initial cementitious powder as a mist.

7. The method of claim 1 in which the amount of water is supplied to the initial cementitious powder as a stream.

8. The method of claim 1 in which the amount of water is supplied to the initial cementitious powder as a vapor.

9. The method of claim 1 in which the carbon dioxide is supplied to the moistened cementitious powder substantially at atmospheric pressure.

10. The method of claim 1 further comprising cooling the moistened cementitious powder during the reaction of the carbon dioxide with the moistened cementitious powder.

11. The method of claim 1 in which the initial cementitious powder is provided by the steps of:
providing a mixture of ground calcareous materials and ground argillaceous materials;
heating the mixture to a temperature sufficient to calcine and fuse the ground materials to form a cement clinker;
cooling the cement clinker; and
grinding the cement clinker to produce the initial cementitious powder.

12. The method of claim 1 in which the carbon dioxide supplied to the initial cement powder is obtained from an exhaust gas of an industrial process.

13. The method of claim 11 in which the step of heating the mixture to a temperature sufficient to calcine and fuse the ground materials produces an exhaust gas containing carbon dioxide, and the carbon dioxide supplied to the moistened cementitious powder is obtained from the exhaust gas.

14. The method of claim 13 in which the carbon dioxide is separated from the exhaust gas before it is supplied to the moistened cementitious powder.

15. The method of claim 13 in which the carbon dioxide is supplied to the moistened cementitious powder by supplying the exhaust gas to the moistened cementitious powder without separating the carbon dioxide.

16. The method of claim 1 further comprising adding a binder to the fully or partially carbonated cementitious material or to the fully or partially carbonated cementitious powder.

17. The method of claim 16 in which the binder is added to the fully or partially carbonated cementitious powder.

18. The method of claim 17 in which the binder is added in a mixing step in which water is also added.

19. The method of claim 17 in which the binder is added to the fully or partially carbonated cementitious powder before adding water.

20. The method of claim 16 in which the fully or partially carbonated cementitious material or the fully or partially carbonated cementitious powder is substantially fully carbonated cementitious material or substantially fully carbonated cementitious powder.

21. The method of claim 16 in which the binder comprises an oxide.

22. The method of claim 21 in which the oxide is magnesium oxide.

23. The method of claim 17 in which the binder comprises a hydroxide.

24. The method of claim 23 in which the hydroxide is sodium hydroxide.

25. The method of claim 16 in which the binder comprises ferric chloride (FeCl₃).

26. The method of claim 1 further comprising including the fully or partially carbonated cementitious powder in a concrete for civil use.

27. The method of claim 1 further comprising including the fully or partially carbonated cementitious powder in a concrete for marine use.

28. The method of claim 1 further comprising including the fully or partially carbonated cementitious powder as the whole or part of a cementitious component of a concrete for use in a wellbore.

29.-50. (canceled)
